(19) United States
(12) Patent Application Publication
(10) Pub. No.: US 2019/0197747 A1
(43) Pub. Date: Jun. 27, 2019

(54) AUTOMATIC OBFUSCATION ENGINE FOR COMPUTER-GENERATED DIGITAL IMAGES

(71) Applicant: IMVU, Inc. a Delaware corporation, Redwood City, CA (US)

(72) Inventors: Llorenç Marti Garcia, Mountain View, CA (US); Morgan Tucker, San Francisco, CA (US)

(73) Assignee: IMVU, Inc.

(21) Appl. No.: 15/853,405

(22) Filed: Dec. 22, 2017

(51) Int. Cl. G06T 11/60; G06K 9/46; G06T 3/40; G06T 11/00; H04L 29/06

(52) U.S. Cl. CPC G06T 11/60; G06K 9/4652; H04L 67/42; G06T 11/001; G06K 9/4609; G06T 3/4015

(57) ABSTRACT

A method and apparatus are disclosed for identifying an object with specific characteristics and automatically obfuscating part or all of a digital image corresponding to that object. The obfuscation comprises pixelation, color alteration, and/or contrast alteration. The obfuscation optionally can be performed only when the digital image is being viewed by certain client devices.

### TECHNICAL FIELD

A method and apparatus are disclosed for identifying an object with specific characteristics and automatically obfuscating part or all of a digital image corresponding to that object. The obfuscation comprises pixelation, color alteration, and/or contrast alteration. The obfuscation optionally can be performed only when the digital image is being viewed by certain client devices.

### BACKGROUND OF THE INVENTION

As computing technology continually improves, the ability to quickly generate and render digital images on a display is becoming more and more sophisticated. Computer-generated images have become extremely realistic and often comprise layers of different details.

At the same time, realistic images are not always desirable for all viewers. For example, if a minor is operating a client device, the content provider may not want that minor to be able to see images containing adult content, such as images containing nudity, violence, or disturbing depictions. Numerous other reasons exist for wanting to shield certain users from certain content. For example, there may be privacy or intellectual property concerns with certain images, or the content provider may wish for only certain individuals, and not the general public, to be able to see the images.

To date, content has been shielded from viewers through access controls, for example, by preventing certain users from accessing certain content altogether, such as by denying access to a video file. This is an overly restrictive approach, as it prevents users from seeing the entire content even though the objectionable portion may be only a small portion of the overall content in terms of pixels or time displayed on the screen.

What is needed is a mechanism for automatically identifying an object for which obfuscation is desired, identifying the specific structure that should be obfuscated, and then obfuscating the structure prior to display on a screen. What is further needed is a mechanism for achieving this result in a way that does not detract from the viewing of the overall image containing the specific structure. What is further needed is the ability to perform such obfuscation only for certain client computing devices and not others.

### SUMMARY OF THE INVENTION

A method and apparatus are disclosed for identifying an object with specific characteristics and automatically obfuscating part or all of a digital image corresponding to that object. The obfuscation comprises pixelation, color alteration, and/or contrast alteration. The obfuscation optionally can be performed only when the digital image is being viewed by certain client devices.

### BRIEF DESCRIPTION OF THE DRAWINGS

FIG. 1 depicts hardware components of a client device.

FIG. 2 depicts software components of the client device.

FIG. 3 depicts a plurality of client devices in communication with a server.

FIG. 4 depicts an obfuscation engine.

FIG. 5 depicts an object identification engine for identifying objects for which an associate image should be obfuscated.

FIG. 6 depicts pixel data and an image for an exemplary object for which obfuscation is to be performed.

FIG. 7 depicts a pixelation engine operating upon pixel data from an object.

FIG. 8 depicts a color engine operating upon pixel data from an object.

FIG. 9 depicts a contrast engine operating upon pixel data from an object.

FIG. 10 depicts a pixelation engine, color engine, and contrast engine operating upon pixel data from an object.

FIG. 11 depicts the display of an image and an altered image derived from the same object, where the image is displayed on one client device and the altered image is concurrently displayed on another client device.

### DETAILED DESCRIPTIONS OF THE PREFERRED EMBODIMENTS

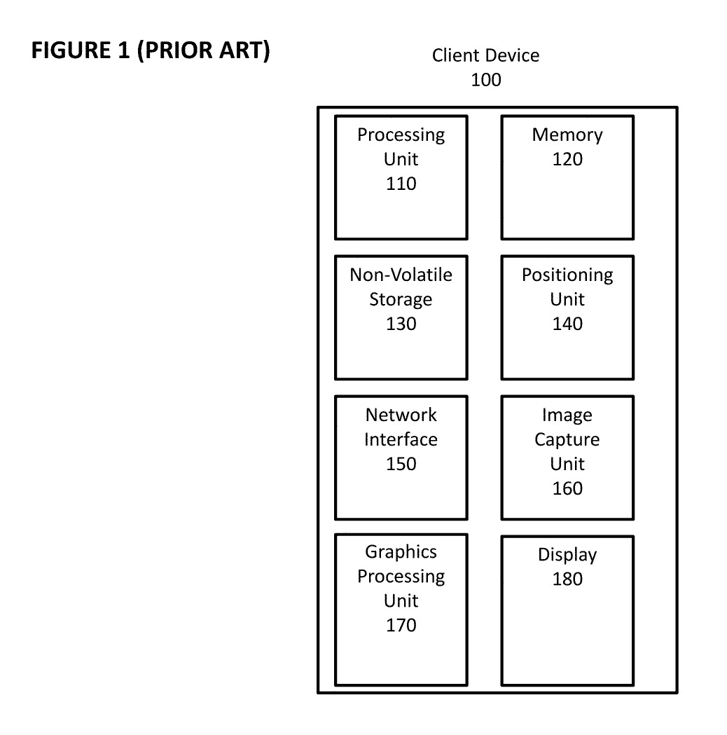

FIG. 1 depicts hardware components of client device 100. These hardware components are known in the prior art. Client device 100 is a computing device that comprises processing unit 110, memory 120, non-volatile storage 130, positioning unit 140, network interface 150, image capture unit 160, graphics processing unit 170, and display 180. Client device 100 can be a smartphone, notebook computer, tablet, desktop computer, gaming unit, wearable computing device such as a watch or glasses, or any other computing device.

Processing unit 110 optionally comprises a microprocessor with one or more processing cores. Memory 120 optionally comprises DRAM or SRAM volatile memory. Non-volatile storage 130 optionally comprises a hard disk drive or flash memory array. Positioning unit 140 optionally comprises a GPS unit or GNSS unit that communicates with GPS or GNSS satellites to determine latitude and longitude coordinates for client device 100, usually output as latitude data and longitude data. Network interface 150 optionally comprises a wired interface (e.g., Ethernet interface) or wireless interface (e.g., 3G, 4G, GSM, 802.11, protocol known by the trademark “Bluetooth,” etc.). Image capture unit 160 optionally comprises one or more standard cameras (as is currently found on most smartphones and notebook computers). Graphics processing unit 170 optionally comprises a controller or processor for generating graphics for display. Display 180 displays the graphics generated by graphics processing unit 170, and optionally comprises a monitor, touchscreen, or other type of display.

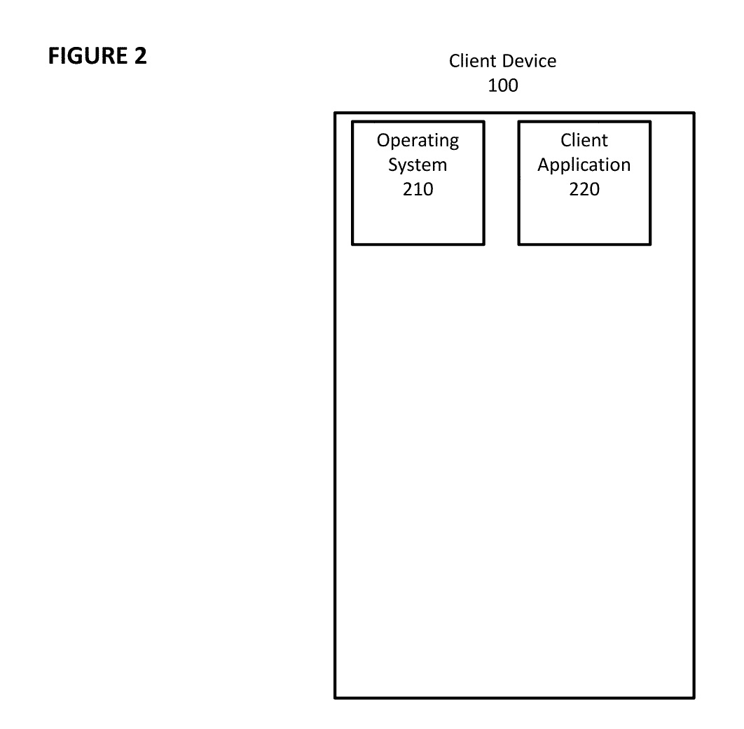

FIG. 2 depicts software components of client device 100. Client device 100 comprises operating system 210 (such as the operating systems known by the trademarks “Windows,” “Linux,” “Android,” “iOS,” or others) and client application 220. Client application 220 comprises lines of software code executed by processing unit 110 and/or graphics processing unit 170 to perform the functions described below. For example, client device 100 can be a smartphone sold with the trademark “Galaxy” by Samsung or “iPhone” by Apple, and client application 220 can be a downloadable app installed on the smartphone or a browser running code obtained from server 300 (described below). Client device 100 also can be a notebook computer, desktop computer, game system, or other computing device, and client application 220 can be a software application running on client device 100 or a browser on client device 100 running code obtained from server 300. Client application 220 forms an important component of the inventive aspect of the embodiments described herein, and client application 220 is not known in the prior art.

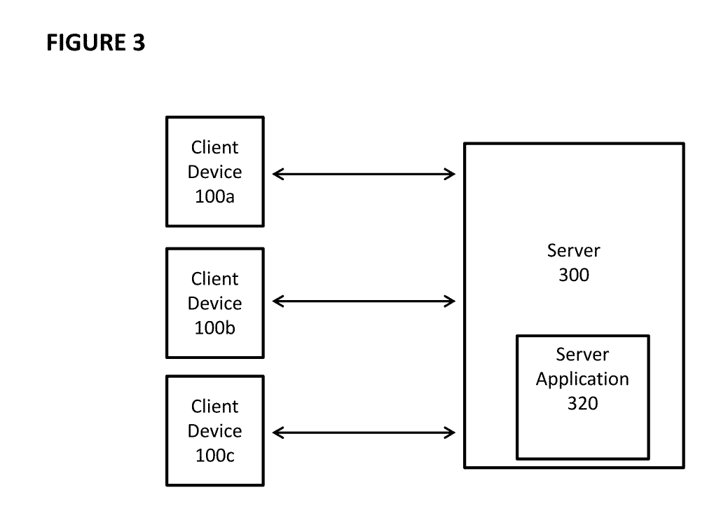

With reference to FIG. 3, three instantiations of client device 100 are shown, client devices 100a, 100b, and 100c. These are exemplary devices, and it is to be understood that any number of different instantiations of client device 100 can be used.

Client devices 100a, 100b, and 100c each communicate with server 300 using network interface 150. Server 300 runs server application 320. Server application 320 comprises lines of software code that are designed specifically to interact with client application 220.

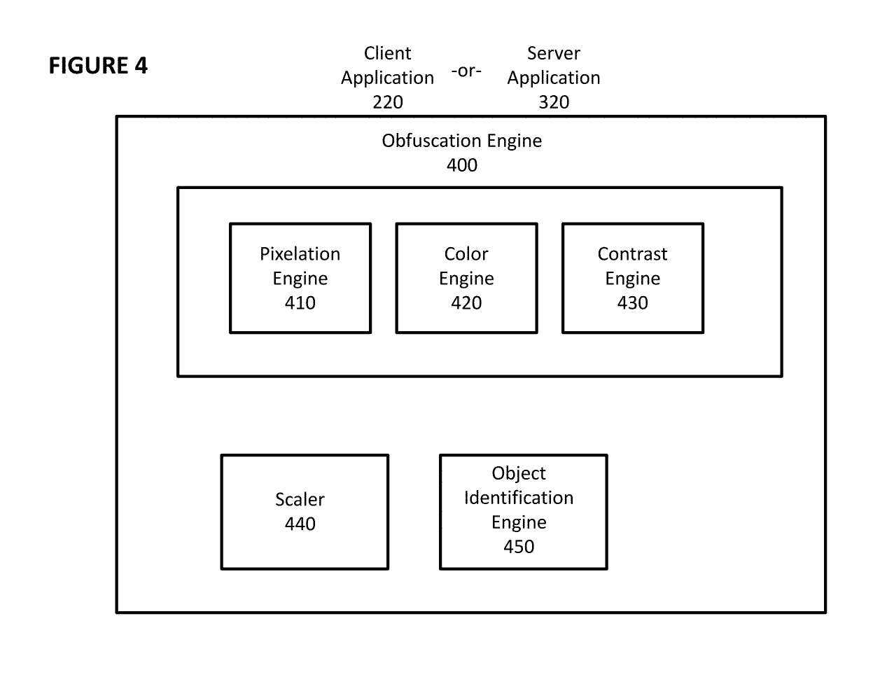

FIG. 4 depicts engines contained within client application 220, within server application 320, or split between client application 220 and server application 320. One of ordinary skill in the art will understand and appreciate that the functions described below can be distributed between server application 320 and client application 220.

Application 220 and/or application server 320 comprise obfuscation engine 400, scaler 440, and object identification engine 450. Obfuscation engine comprises pixelation engine 410, color engine 420, and/or contrast engine 430. Obfuscation engine 400, pixelation engine 410, color engine 420, contrast engine 430, scaler 440, and object identification engine 450 each comprises lines of software code executed by processing unit 110 and/or graphics processing unit 170, and/or comprises additional integrated circuitry, to perform certain functions. For example, scaler 440 might comprise software executed by processing unit 110 and/or graphics processing unit 170 and/or might comprise hardware scaling circuitry comprising integrated circuits.

Obfuscation engine 400 receives an input, typically comprising pixel data, and performs an obfuscation function using one or more of pixelation engine 410, color engine 420, contrast engine 430, and/or other engines on the input to generate an output, where the output can then be used to generate an image that is partially or wholly obfuscated.

Pixelation engine 410 performs an obfuscation function by receiving input pixel data and pixelating the received input pixel data to generate output pixel data, where the output pixel data generally contains fewer pixels than the input pixel data and each individual pixel in the output pixel data is based on one or more pixels in the input pixel data.

Color engine 420 performs an obfuscation function by receiving input pixel data and altering the color of one or more pixels in the input pixel data to generate output pixel data.

Contrast engine 430 performs an obfuscation function by receiving input pixel data and altering the contrast between two or more pixels in the input pixel data to generate output pixel data.

Scaler 440 performs a scaling function by receiving input pixel data and scaling the input pixel data to generate output pixel data. Scaler 440 can be used, for example, if the input pixel data is arranged in a different size configuration (e.g., y rows of x pixels per row) than the size configuration of display 180 of client device 100 on which the image is to be displayed (e.g., c rows of d pixels per row).

Object identification engine 450 identifies one or more objects or sub-objects upon which obfuscation is to be performed.

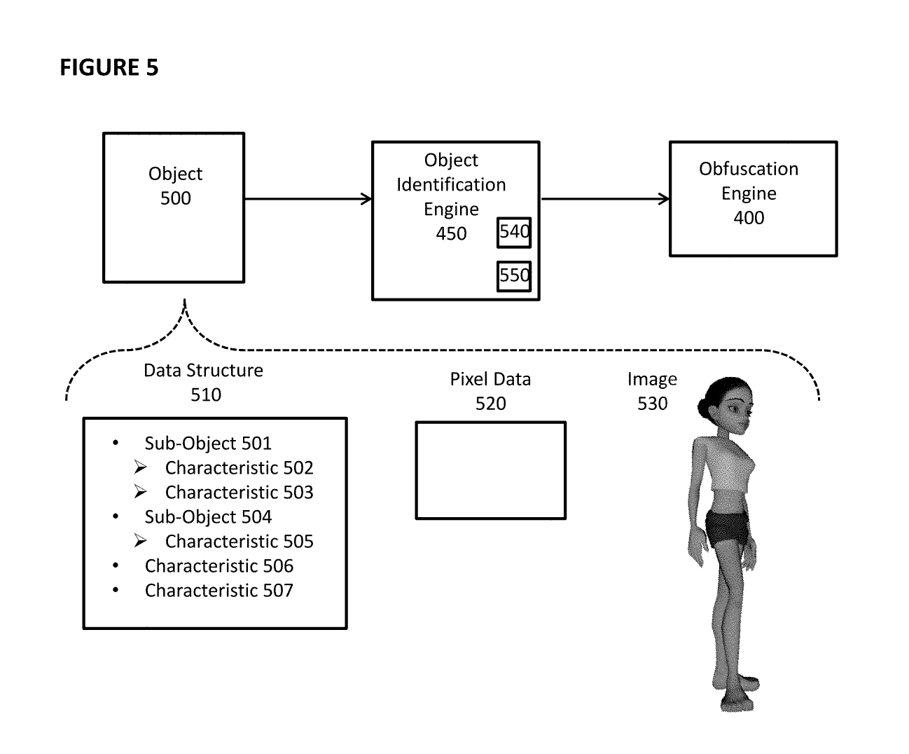

With reference to FIG. 5, object identification engine 450 analyzes object 500 and provides an input to obfuscation engine 400. Object 500 optionally comprises data structure 510 and is associated with pixel data 520 and image 530. Data structure 510 comprises sub-objects 501 and 504 and characteristics 506 and 507. Sub-object 501 comprises characteristics 502 and 503, and sub-object 504 comprises characteristic 505. Pixel data 520 optionally corresponds to object 500 at a specific moment in time, and image 530 is the image that would be generated based on pixel data 520 if no alteration occurred.

An example of object 500 might be a character in a video game or virtual world, and examples of sub-objects 501 and 504 might be a shirt and pants that the character wears. Another example of object 500 might be a digital photograph, and examples of sub-objects 501 and 504 might be a face and body. Another example of object 500 might be landscape imagery, and examples of sub-objects 501 and 504 might be sunlight and a mountain. One of ordinary skill in the art will appreciate that these examples are not limiting, and object 500 can be any number of possible objects.

Optionally, one or more of characteristics 502, 503, 505, 506, and 507 can be a characteristic for which obfuscation is desired. For example, the characteristic might indicate that an item is secret or private (such as a person's face/identity, or financial information) or that the item is not appropriate for viewing by all audiences (such as an item with sexual content, violent content, etc.). In the example where object 500 is a character in a video game or virtual world and sub-object 501 is a shirt, characteristic 502 might be “adult only,” “see-through,” or “invisible.” Object identification engine 450 examines all portions of object 500 and identifies sub-objects or objects for which obfuscation is desired, such as sub-object 501 (e.g., a see-through shirt). Once such items are identified, object identification engine 450 sends the object 500, sub-object 501, or their associated pixel data to obfuscation engine 400.

In another embodiment, object identification engine 450 comprises image recognition engine 540, which will analyze pixel data 520 or image 530 and compare it to a set of known pixel data or images contained in database 550. If a match is found, then object identification engine 450 will identify object 500 or a relevant sub-object as an object to be obfuscated and sends object 500, the relevant sub-object 501, or their associated pixel data to obfuscation engine 400. This embodiment is useful for identifying known images for which obfuscation is desired. For example, one might do this with images protected by a copyright or trademark for which no license has been obtained, or one might also do this with images known to be offensive.

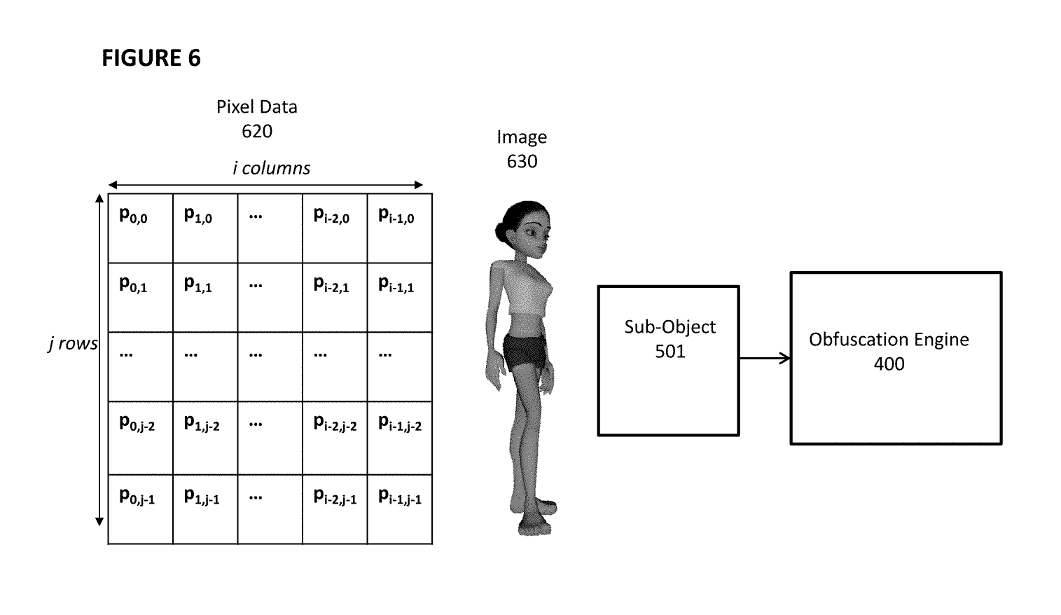

With reference now to FIG. 6, it is assumed that sub-object 501 is sent to obfuscation engine 400, along with pixel data 620, where pixel data 620 is the portion of pixel data 520 that corresponds to sub-object 501 (e.g., shirt). In this embodiment, Pixel data 620 comprises an array of pixel data, the array comprising i columns and j rows of pixel data values, p_{column, row}, where each pixel data value contains data that can be used to generate a pixel on display 180. For example, p_{column, row} can comprise 32 bits (8 bits for red, 8 bits for green, 8 bits for blue, and optionally, 8 bits for alpha channel or transparency). One of ordinary skill in the art will appreciate that p_{column, row} can comprise other numbers of bits and that 32 bits is just one possible embodiment. It is to be further understood that pixel data 620 need not be in array form and could constitute any collection of pixel data values. Obfuscation engine 400 will act upon pixel data 620 using one or more of pixelation engine 410, color engine 420, and contrast engine 430. Image 630 is the image that would be displayed based on pixel data 620 absent any alteration.

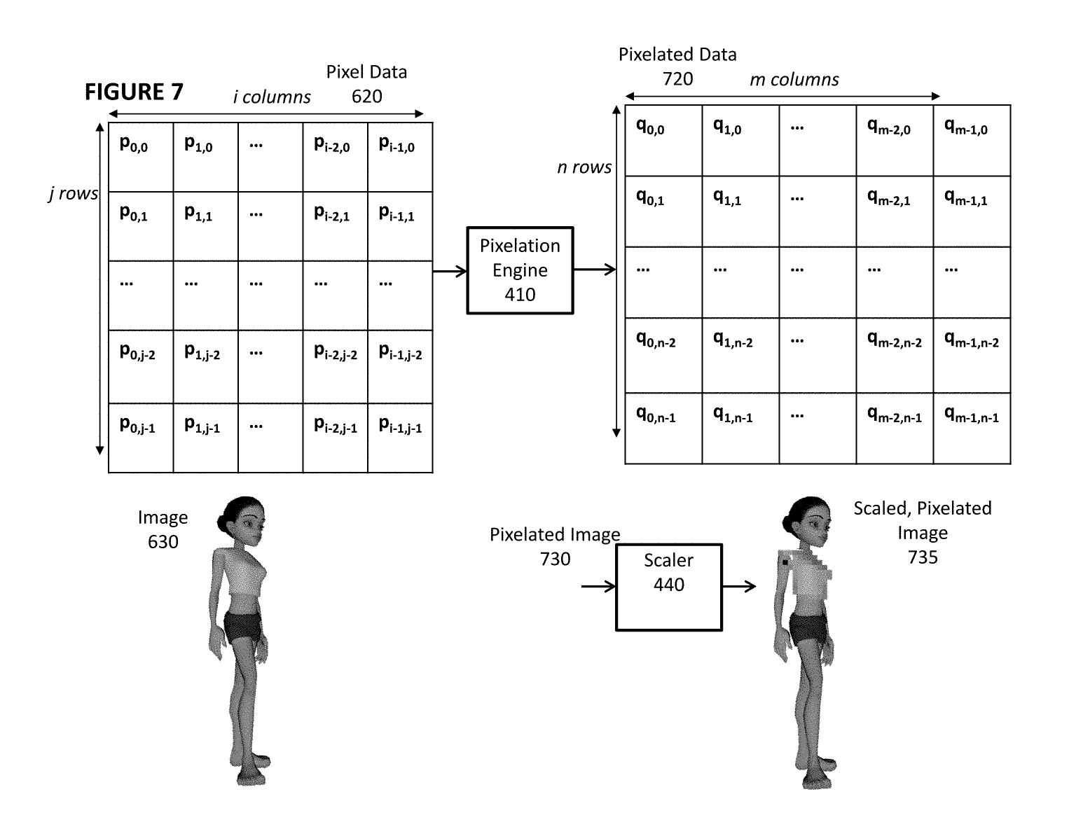

In FIG. 7, pixelation engine 410 is shown. Pixelation engine 410 receives pixel data 620 and pixelates the data to generate pixelated data 720. In this embodiment, pixelated data comprises an array of pixel data, the array comprising m columns of n rows of pixel data value, q_{column, row}, where each pixel data value contains data that can be used to generate a pixel on display 180. Typically, m<i and n<j. For instance, i and j might be 32 and 32, and m and n might be 16 and 16 or 8 and 8. That is, a 32×32 array of pixel data might be pixelated into an array of 16×16 or 8×8. In this example, q_{column, row} can comprise 32 bits (8 bits for red, 8 bits for green, 8 bits for blue, and optionally, 8 bits for alpha channel or transparency). One of ordinary skill in the art will appreciate that q_{column, row} can comprise other numbers of bits and that 32 bits is just one possible embodiment.

There are numerous approaches for determining the value of each q_{column, row}. In one embodiment, q_{column,row} is a weighted average of all pixels in pixel data 620 that are within the same relative location within the array. For example, when pixelated data 720 is a 16×16 array, the second pixel in the top row can be considered to occupy a space equal to 1/16 of the width of the array× 1/16 of the height of the array, starting at a location that is 1/16 in from the left edge in the horizontal direction and at the top edge in the vertical direction. With that relative size and location in mind, one could then determine the same relative size and location in the 32×32 array represented by pixel data 620. Because pixel data 620 has a larger array size than pixelated data 720, each pixel q_{column, row} will correspond to some or all of more than one pixel p_{column, row}. q can be calculated as a weighted average of those p values based on the portion of p that is covered by the q pixel.

Contained below is exemplary source code that can be used by pixelation engine 410 for performing the pixelation function. This code can be used to obtain samples on many positions within pixel data 620 on a given texture and to perform an average on those values to generate a pixel value. In this exemplary code, the variable “color” is q_{column, row}.

vec4 color;
vec2 origin = getSampleOrigin( );
float sampleWidth = pixelWidth / widthSamples;
float sampleHeight = pixelHeight / heightSamples;
for (int i = 0; i < widthSamples; i++) {

for (int j = 0; j < heightSamples; j++) {

vec2 coord = origin + vec2(sampleWidth * i, sampleHeight * j);

color += texture2D( tMap, coord).rgb;

}

}
color /= (float)(widthSamples * heightSamples);

Because pixelated data 720 will not have the same array size as pixel data 620, the resulting pixelated image 730 will be smaller than image 630. However, the end result will be scaled by scaler 440 into the appropriate size for display 180, resulting in scaled, pixelated image 735.

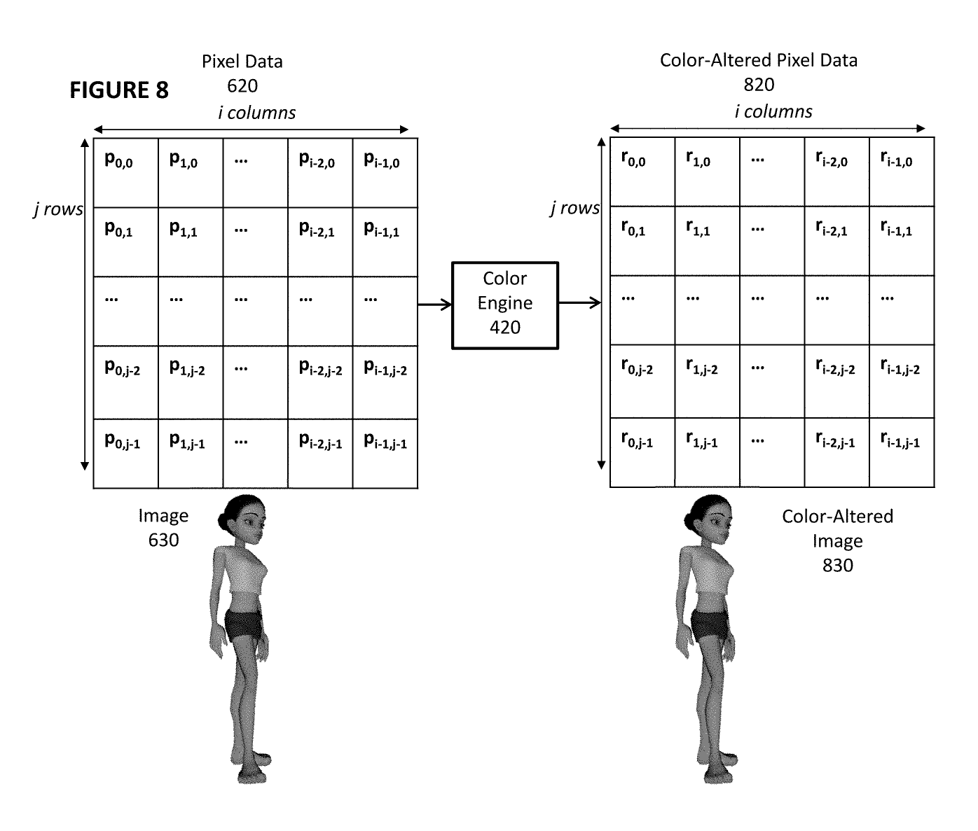

In FIG. 8, color engine 420 is shown. Color engine 420 receives pixel data 620 and alters the color of one or more pixels in pixel data 620 to generate color-altered pixel data 820. Here, the array sizes of pixel data 620 and color-altered pixel data 820 are the same (i.e., i columns×j rows). However, color engine 420 applies a filter to each pixel data value p_{column, row} to generate a color-altered pixel data value r_{column, row}. In this example, r_{column, row} can comprise 32 bits (8 bits for red, 8 bits for green, 8 bits for blue, and optionally, 8 bits for alpha channel or transparency). One of ordinary skill in the art will appreciate that r_{column, row} can comprise other numbers of bits and that 32 bits is just one possible embodiment.

Any number of different filters can be applied. For example, a grayscale filter can be applied to translate each pixel data value p_{column, row} into a gray-scale value, such that the resulting color-altered image 830 is a gray-scale image. As another example, a bright color filter can be applied to translate each pixel data value p_{column, row} into a bright color selected from a specific set of bright colors (e.g., fuchsia, bright green, etc.). As another example, a sepia filter can be applied to translate each pixel data value p_{column, row} into a sepia-colored value.

Contained below is exemplary source code that can be used by color engine 420 for performing the color alteration function to generate a sepia-colored value. This code will transform the given color into a sepia tone color. Here, sepiaColor.r is the “r” value, sepiaColor.g is the “g” value, sepia.Color.b is the “b” value, and sepiaColor.a is the “a” value of for r_{column, row}.

vec4 color;
vec4 sepiaColor;
sepiaColor.r = (color.r * 0.393) + (color.g * 0.769) + (color.b * 0.189);
sepiaColor.g = (color.r * 0.349) + (color.g * 0.686) + (color.b * 0.168);
sepiaColor.b = (color.r * 0.272) + (color.g * 0.534) + (color.b * 0.131);
sepiaColor.a = color.a;

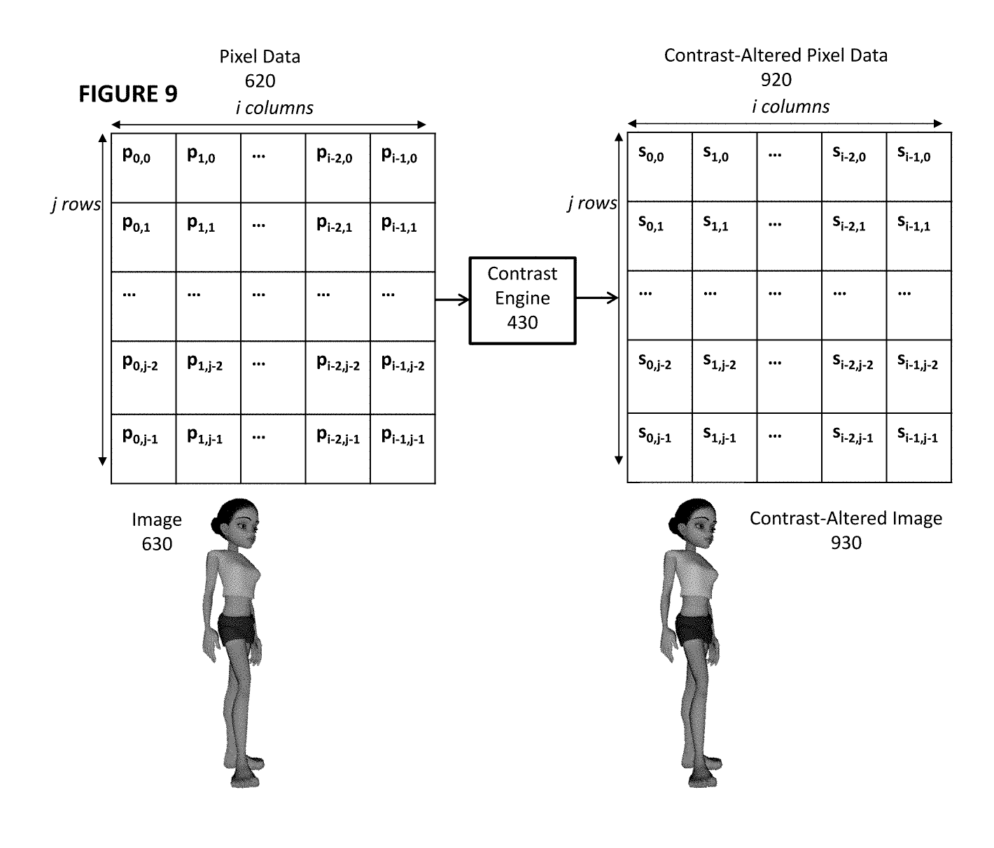

In FIG. 9, contrast engine 430 is shown. Contrast engine 430 receives pixel data 620 and alters the contrast between pixels to generate contrast-altered pixel data 820. Here, the array sizes of pixel data 620 and contrast-altered pixel data 820 are the same (i.e., i columns×j rows). However, contrast engine 420 applies a filter to each pixel data value p_{column, row} to generate a contrast-altered pixel data value s_{column, row}. In this example, s_{column, row} can comprise 32 bits (8 bits for red, 8 bits for green, 8 bits for blue, and optionally, 8 bits for alpha channel or transparency). One of ordinary skill in the art will appreciate that s_{column, row} can comprise other numbers of bits and that 32 bits is just one possible embodiment.

Any number of different contrast filters can be applied. For example, filter can be applied to increase the contrast between pixels. Or a filter can be applied to decrease the contrast between pixels. The latter is typically more useful in obfuscating images for the human eye.

Contained below is exemplary source code that can be used by contrast engine 430 for performing the contrast alteration function to alter the contrast between pixels. In this example, the code decreases the contrast of the given color by making an interpolation towards white, controlled by contrastFactor. Here, the variable color.rgb is s_{column, row}.

vec4 color;
color.rgb = mix(color.rgb, vec3(1.0), contrastFactor);

It is to be understood that pixelation engine 410, color engine 420, and contrast engine 430 can be applied in varying combinations and in different orders. For example, only one of them might be applied or two or three of them can be applied, and the order in which they are applied can vary. Obfuscation engine 400 optionally will allow the administrator of application server 320 to select which engine to apply in a given situation.

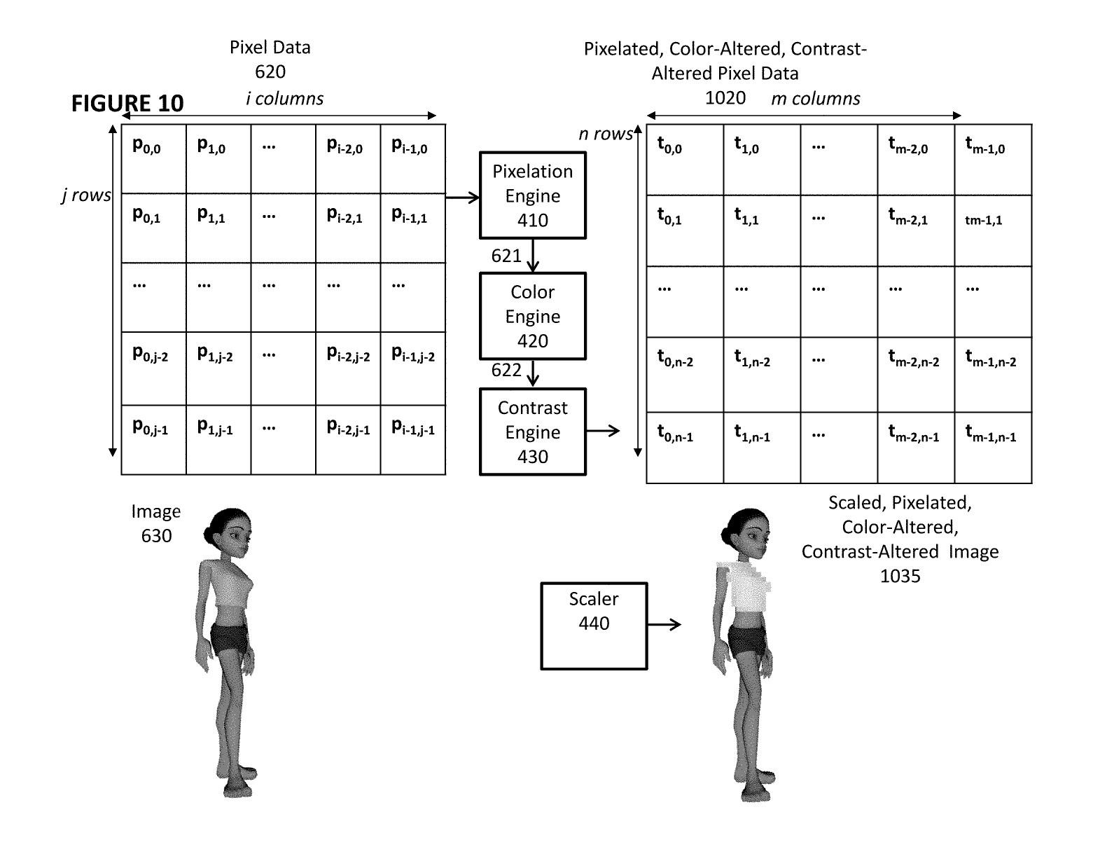

In FIG. 10, an example is shown where that pixelation engine 410, color engine 420, and contrast engine 430 are all applied. Here, pixelation engine 410 receives pixel data 620. Its output 621 is then provided to color engine 420, and then the output 622 of color engine 420 is provided as an input to contrast engine 430. The end result is pixelated, color-altered, contrast-altered pixel data 1020, comprising an array of pixel data, the array comprising m columns of n rows of pixel data value, t_{column, row}, where each pixel data value contains data that be used to generate a pixel on display 180. In this example, t_{column, row} can comprise 32 bits (8 bits for red, 8 bits for green, 8 bits for blue, and optionally, 8 bits for alpha channel or transparency). One of ordinary skill in the art will appreciate that t_{column, row} can comprise other numbers of bits and that 32 bits is just one possible embodiment. Scaler 440 ultimately will be used to scale the image to the ideal size for display 180, here shown as scaled, pixelated, color-altered, contrast-altered image 1035.

The value of the invention can be seen in comparing scaled, pixelated, color-altered, contrast-altered image 1035 to image 630 in FIG. 10. The obfuscation is readily apparent, and its value can be appreciated by those of ordinary skill in the art as well as anyone who has ever desired to shield minors or other users from certain content.

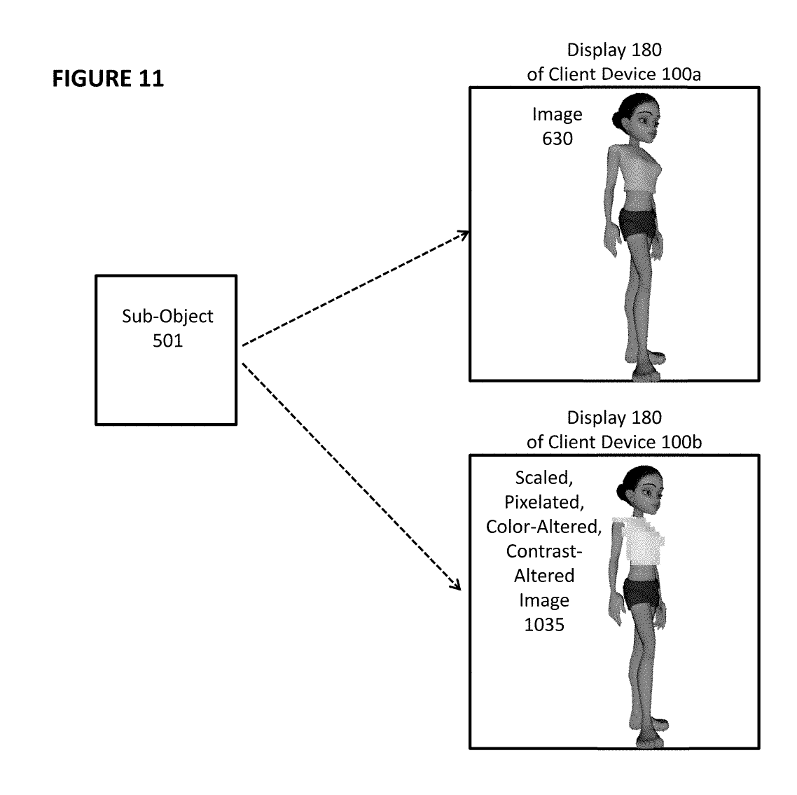

In FIG. 11, obfuscation engine 400 can be utilized only for certain client devices 100. In this example, client device 100a is operated by an adult and client device 100b is operated by a minor. This information is known by server 300, for example, based on the user profiles of the users operating client devices 100a and 100b. As a result, object identification engine 450 determines that obfuscation of sub-object 501 is desired for client device 100b but not for client device 100a. Thereafter, client device 100a renders image 630, which is an unaltered image generated for object 500, but client device 100b renders scaled, pixelated, color-altered, contrast-altered image 1035.

In the example where object 500 is a character and sub-object 501 is a see-through shirt, the character would appear on client device 100a in a see-through shirt, but the character would appear on client device 100b in an obfuscated shirt.

References to the present invention herein are not intended to limit the scope of any claim or claim term, but instead merely make reference to one or more features that may be covered by one or more of the claims. Materials, processes and numerical examples described above are exemplary only, and should not be deemed to limit the claims. It should be noted that, as used herein, the terms “over” and “on” both inclusively include “directly on” (no intermediate materials, elements or space disposed there between) and “indirectly on” (intermediate materials, elements or space disposed there between). Likewise, the term “adjacent” includes “directly adjacent” (no intermediate materials, elements or space disposed there between) and “indirectly adjacent” (intermediate materials, elements or space disposed there between). For example, forming an element “over a substrate” can include forming the element directly on the substrate with no intermediate materials/elements there between, as well as forming the element indirectly on the substrate with one or more intermediate materials/elements there between.

1. A method of automatically generating an obfuscated image, comprising:
receiving characteristics data for an object comprising a first sub-object and a second sub-object;
determining, based on the characteristics data, that the first sub-object should be obfuscated;
receiving a first set of pixel data for the first sub-object and a second set of pixel data for the second sub-object, the first set of pixel data comprising data elements for each pixel in a first plurality of pixels and the second set of pixel data comprising data elements for each pixel in a second plurality of pixels; and
transforming the first set of pixel data into a third set of pixel data, the third set of pixel data comprising data elements for each pixel in a third plurality of pixels, wherein the third plurality of pixels is fewer in number than the first plurality of pixels and each of the data elements in the third set of pixel data is calculated from data elements for one or more of the pixels in the first plurality of pixels.

2. The method of claim 1, further comprising:
scaling the third set of pixel data to generate a fourth set of pixel data, the fourth set of pixel data comprising data elements for each pixel in a fourth plurality of pixels; and
rendering, on a display of a first computing device, an image comprising the second plurality of pixels and the fourth plurality of pixels.

3. The method of claim 1, further comprising:
altering the color content of the third set of pixel data to generate a fourth set of pixel data, the fourth set of pixel data comprising data elements for each pixel in a fourth plurality of pixels; and
scaling the fourth set of pixel data to generate a fifth set of pixel data, the fifth set of pixel data comprising data elements for each pixel in a fourth plurality of pixels; and
rendering, on a display of a first computing device, an image comprising the second plurality of pixels and the fifth plurality of pixels.

4. The method of claim 1, further comprising:
altering the third set of pixel data to alter the contrast between pixels in the third set of pixel data to generate a fourth set of pixel data, the fourth set of pixel data comprising data elements for each pixel in a fourth plurality of pixels;
scaling the fourth set of pixel data to generate a fifth set of pixel data, the fifth set of pixel data comprising data elements for each pixel in a fifth plurality of pixels; and
rendering, on a display of a first computing device, an image comprising the second plurality of pixels and the fifth plurality of pixels.

5. The method of claim 1, further comprising:
altering the color content of the third set of pixel data to generate a fourth set of pixel data, the fourth set of pixel data comprising data elements for each pixel in a fourth plurality of pixels;
altering the fourth set of pixel data to alter the contrast between pixels in the fourth set of pixel data to generate a fifth set of pixel data, the fifth set of pixel data comprising data elements for each pixel in a fifth plurality of pixels;
scaling the fifth set of pixel data to generate a sixth set of pixel data, the sixth set of pixel data comprising data elements for each pixel in a sixth plurality of pixels; and
rendering, on a display of a first computing device, an image comprising the second plurality of pixels and the sixth plurality of pixels.

6. (canceled)

7. The method of claim 2, further comprising:
rendering, on a display of a second computing device, an image comprising the second plurality of pixels and the first plurality of pixels.

8. The method of claim 3, further comprising:
rendering, on a display of a second computing device, an image comprising the second plurality of pixels and the first plurality of pixels.

9. The method of claim 4, further comprising:
rendering, on a display of a second computing device, an image comprising the second plurality of pixels and the first plurality of pixels.

10. The method of claim 5, further comprising:
rendering, on a display of a second computing device, an image comprising the second plurality of pixels and the first plurality of pixels.

11. A computing system comprising a processing unit configured by a program of instructions to:
receive characteristics data for an object comprising a first sub-object and a second sub-object;
determine, based on the characteristics data, that the first sub-object should be obfuscated;
receive a first set of pixel data for the first sub-object and a second set of pixel data for the second sub-object, the first set of pixel data comprising data elements for each pixel in a first plurality of pixels and the second set of pixel data comprising data elements for each pixel in a second plurality of pixels; and
transform the first set of pixel data into a third set of pixel data, the third set of pixel data comprising data elements for each pixel in a third plurality of pixels, wherein the third plurality of pixels is fewer in number than the first plurality of pixels and each of the data elements in the third set of pixel data is calculated from data elements for one or more of the pixels in the first plurality of pixels.

12. The computing system of claim 11, wherein the processing unit is further configured by the program of instructions to:
scale the third set of pixel data to generate a fourth set of pixel data, the fourth set of pixel data comprising data elements for each pixel in a fourth plurality of pixels; and
render, on a first display, an image comprising the second plurality of pixels and the fourth plurality of pixels.

13. The computing system of claim 11, wherein the processing unit is further configured by the program of instructions to:
alter the color content of the third set of pixel data to generate a fourth set of pixel data, the fourth set of pixel data comprising data elements for each pixel in a fourth plurality of pixels;
scale the fourth set of pixel data to generate a fifth set of pixel data, the fifth set of pixel data comprising data elements for each pixel in a fifth plurality of pixels; and
render, on a first display, an image comprising the second plurality of pixels and the fifth plurality of pixels.

14. The computing system of claim 11, wherein the processing unit is further configured by the program of instructions to:
alter the third set of pixel data to alter the contrast between pixels in the third set of pixel data to generate a fourth set of pixel data, the fourth set of pixel data comprising data elements for each pixel in a fourth plurality of pixels;
scale the fourth set of pixel data to generate a fifth set of pixel data, the fifth set of pixel data comprising data elements for each pixel in a fifth plurality of pixels; and
render, on a first display, an image comprising the second plurality of pixels and the fifth plurality of pixels.

15. The computing system of claim 11, wherein the processing unit is further configured by the program of instructions to:
alter the color content of the third set of pixel data to generate a fourth set of pixel data, the fourth set of pixel data comprising data elements for each pixel in a fourth plurality of pixels;
alter the fourth set of pixel data to alter the contrast between pixels in the fourth set of pixel data to generate a fifth set of pixel data, the fifth set of pixel data comprising data elements for each pixel in a fifth plurality of pixels;
scale the fifth set of pixel data to generate a sixth fifth set of pixel data, the sixth set of pixel data comprising data elements for each pixel in a sixth plurality of pixels; and
render, on a first display, an image comprising the second plurality of pixels and the sixth plurality of pixels.

16. (canceled)

17. The computing system of claim 12, further comprising another processing unit configured by a program of instructions to:
render, on a second display, an image comprising the second plurality of pixels and the first plurality of pixels.

18. The computing system of claim 13, further comprising another processing unit configured by a program of instructions to:
render, on a second display, an image comprising the second plurality of pixels and the first plurality of pixels.

19. The computing system of claim 14, further comprising another processing unit configured by a program of instructions to:
render, on a second display, an image comprising the second plurality of pixels and the first plurality of pixels.

20. The computing system of claim 15, further comprising another processing unit configured by a program of instructions to:
render, on a second display, an image comprising the second plurality of pixels and the first plurality of pixels.
